(19) United States
(12) Patent Application Publication
(10) Pub. No.: US 2026/0120365 A1
(43) Pub. Date: Apr. 30, 2026

(54) METHOD, APPARATUS, DEVICE AND STORAGE MEDIUM FOR GENERATING DECORATION ELEMENT

(71) Applicant: Lemon Inc., Grand Cayman (KY)

(72) Inventors: Angtian Wang, Los Angeles, CA (US); Haibin Huang, Los Angeles, CA (US); Chongyang Ma, Culver City, CA (US); Peilin Li, Los Angeles, CA (US); Jie Meng, Los Angeles, CA (US)

(21) Appl. No.: 19/373,232

(22) Filed: Oct. 29, 2025

(30) Foreign Application Priority Data
Oct. 29, 2024 (CN) 202411524306.7

(51) Int. Cl. G06T 11/60; G06F 40/40; G06T 7/10; G06T 11/40

(52) U.S. Cl. CPC G06T 11/60; G06F 40/40; G06T 7/10; G06T 11/40

(57) ABSTRACT

The embodiment of the disclosure relates to a method, apparatus, device and storage medium for generating decoration element. The method includes: obtaining input information indicating an element category and an element style; providing a target decoration element generated based on the input information, wherein the target decoration element is generated by: determining mask information corresponding to the element category, the mask information indicating a target area for generating a decoration element; providing a reference image, the mask information, and a first prompt corresponding to the input information to a first target model to indicate the first target model to fill the target area in the reference image; and generating the target decoration element based on a filling result of the target area. According to the embodiment of the disclosure, the quality of the generated decoration element can be improved.

### CROSS-REFERENCE

This application claims the priority to Chinese Patent Application No. 202411524306.7, entitled “METHOD, APPARATUS, DEVICE AND STORAGE MEDIUM FOR GENERATING DECORATION ELEMENT” filed on Oct. 29, 2024, the entire contents of which are incorporated herein by reference.

### FIELD

Example embodiments of the present disclosure generally relate to the field of computers, and in particular, to a method, apparatus, device and computer-readable storage medium for generating decoration element.

### BACKGROUND

With the development of the level of the computer, artificial intelligence technology gradually enters the field of image processing, such that the image processing software can generate and provide a wide variety of decoration elements.

However, these generated decoration elements provided lack authenticity, thereby affecting the user experience.

### SUMMARY

In a first aspect of the present disclosure, a method for generating a decoration element is provided. The method comprises: obtaining input information indicating an element category and an element style; and providing a target decoration element generated based on the input information, wherein the target decoration element is generated by: determining mask information corresponding to the element category, the mask information indicating a target area for generating a decoration element; providing a reference image, the mask information, and a first prompt corresponding to the input information to a first target model to indicate the first target model to fill the target area in the reference image; and generating the target decoration element based on a filling result of the target area.

In a second aspect of the present disclosure, an apparatus for generating a decoration element is provided. The apparatus comprises: an obtaining module, configured to obtain input information indicating an element category and an element style; and a providing module, configured to provide a target decoration element generated based on the input information, wherein the target decoration element is generated by: determining mask information corresponding to the element category, the mask information indicating a target area for generating a decoration element; providing a reference image, the mask information, and a first prompt corresponding to the input information to a first target model to indicate the first target model to fill the target area in the reference image; and generating the target decoration element based on a filling result of the target area.

In a third aspect of the present disclosure, an electronic device is provided. The device comprises at least one processing unit; and at least one memory, wherein the at least one memory is coupled to the at least one processing unit and stores instructions for execution by the at least one processing unit. The instructions, when executed by the at least one processing unit, cause the device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description in connection with the accompanying drawings. In the drawings, the same or similar reference numbers refer to the same or similar elements, wherein:

FIG. 1 illustrates a schematic diagram of an example environment in which embodiments according to the present disclosure may be implemented;

FIG. 2 illustrates a flowchart of an example process of providing a decoration element according to some embodiments of the present disclosure;

FIGS. 3A-3C illustrate example interfaces in accordance with some embodiments of the present disclosure;

FIG. 4 illustrates a flowchart of an example process of generating a decoration element according to some embodiments of the present disclosure;

FIG. 5 illustrates a flowchart of an example process of generating a decoration element according to some embodiments of the present disclosure;

FIG. 6 illustrates a flowchart of an example process of generating a reference image according to some embodiments of the present disclosure;

FIG. 7 illustrates a schematic structural block diagram of an example apparatus for providing a decoration element according to some embodiments of the present disclosure; and

FIG. 8 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the protection scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “comprising” and the like should be understood to include “comprising but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, all data is collected, obtained, processed, manufactured, forwarded, used, etc., all of which are performed on the premise that the user knows and confirms. Accordingly, when implementing the embodiments of the present disclosure, the types, the usage scope, the usage scenario, and the like of the data or information that may be involved, should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, the processing may be performed on the premise of having a legality basis (for example, obtaining consent of a personal information subject, or necessary for performing a fulfillment contract), and processing only within a specified or agreed range. The user rejects personal information other than necessary information required by the basic function, and does not affect the basic function of the user.

As mentioned above, some conventional solutions can support users to add elements, such as stickers, and the like generated based on artificial intelligence technology. However, the decoration element generated by the conventional solution cannot be adapted to the decorated image. For example, when the decoration element is used, problems such as improper size of the decoration element, improper position and the like occur, thereby affecting the user experience.

The embodiment of the present disclosure provides a scheme for providing a decoration element. The method comprises: obtaining input information indicating an element category and an element style; and providing a target decoration element generated based on the input information, wherein the target decoration element is generated by: determining mask information corresponding to the element category, the mask information indicating a target area for generating a decoration element; providing a reference image, the mask information, and a first prompt corresponding to the input information to a first target model to indicate the first target model to fill the target area in the reference image; and generating the target decoration element based on a filling result of the target area.

According to the embodiments of the present disclosure, by providing the reference image, the mask information corresponding to the element category and the first prompt corresponding to the input information to the first target model, the embodiments of the present disclosure can effectively define the area for generating the target decoration element when generating the target decoration element, to define the size and the position of the target decoration element, such that the adaptability and the authenticity of the target decoration element are enhanced, and the use experience of the user is improved.

Various example implementations of this solution are described in detail below in connection with the accompanying drawings.

### Example Environment

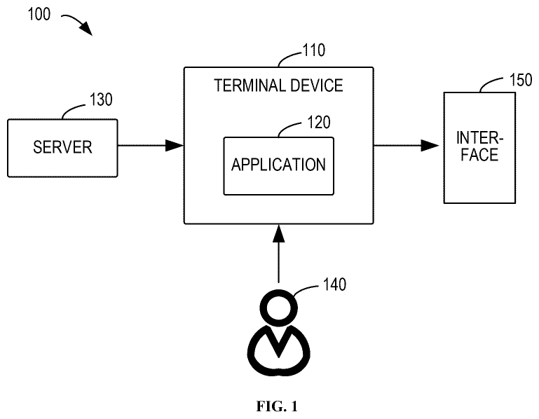

FIG. 1 illustrates a schematic diagram of an example environment 100 in which embodiments of the present disclosure can be implemented. As shown in FIG. 1, the example environment 100 may comprise a terminal device 110.

In this example environment 100, the terminal device 110 may run an application 120 for providing the decoration element. Application 120 may be any suitable type of application for providing the decoration elements, examples of which may include, but are not limited to, image processing applications or other suitable applications. The user 140 may interact with the application 120 via the terminal device 110 and/or its attachment device.

In the environment 100 of FIG. 1, if the application 120 is in an active state, the terminal device 110 may present an interface 150 for providing the decoration element through the application 120.

In some embodiments, terminal device 110 communicates with server 130 to enable provisioning of services to application 120. The terminal device 110 may be any type of mobile terminal, a fixed terminal, or a portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a game device, or any combination thereof, including accessories and peripherals of these devices, or any combination thereof. In some embodiments, the terminal device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide a background service for the application 120 used to provide the decoration element in the terminal device 110.

A communication connection may be established between the server 130 and the terminal device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the terminal device 110 may implement signaling interaction by using a communication connection between the server 130 and the terminal device 110.

It should be understood that the structures and functions of the various elements in the environment 100 are described for exemplary purposes only and do not imply any limitation to the scope of the present disclosure.

Some example embodiments of the present disclosure will be described below with continued reference to the accompanying drawings.

### Example Processes

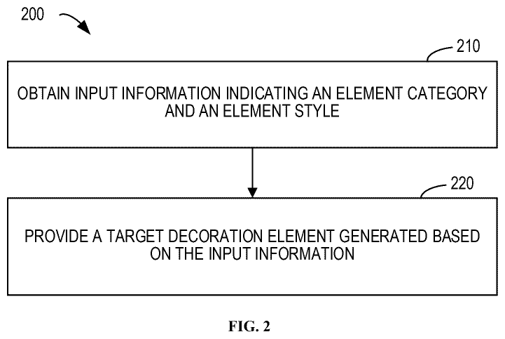

FIG. 2 illustrates a flowchart of an example process 200 of providing a decoration element according to some embodiments of the present disclosure. Process 200 may be implemented at terminal device 110. The process 200 is described below with reference to FIG. 1.

As shown in FIG. 2, at block 210, the terminal device 110 obtains input information. The input information indicates an element category and an element style.

In some embodiments, the input information may comprise input content obtained by the terminal device 110 from the user 140. As an example, the user may input the element category and the element style through text input or other input manners such as voice input. In some embodiments, the element category is a type of decoration element required by the user, examples of which may comprise, but are not limited to, glasses, hats, beards, and the like. Additionally, the element style may indicate a style of the decoration element, examples of which may comprise, but are not limited to, a pattern, a color, and a style.

In some examples, the input information may comprise, for example, text content for indicating an element category and an element style, for example, “hat with a peach blossom pattern”, where “hat” may represent an element category, and “with a peach blossom pattern” may represent an element style.

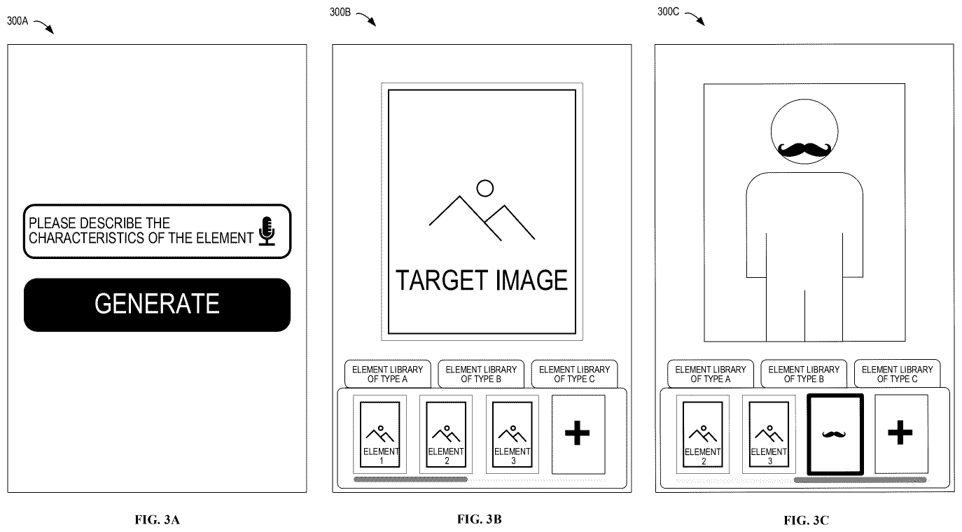

In some embodiments, as shown in FIG. 3A, the terminal device 110 may present an interface 300A configured with a corresponding input box. As an example, as shown in FIG. 3B, after the terminal device 110 receives the operation information of the user in the interface 300B, the terminal device 110 displays the interface 300A.

At block 220, the terminal device 110 provides a target decoration element generated based on the input information. The target decoration element conforms to the element category and the element style proposed by the user.

In some embodiments, as shown in FIG. 3C, after the target decoration element is generated, the terminal device 110 may present the generated target decoration element in the interface 300C. As an example, the terminal device 110 may present a preview effect of the target decoration element applied to the decorated image.

It should be understood that the element generation interface shown in FIG. 3A to FIG. 3C is merely an example, and other suitable interfaces may be utilized to generate and provide the decoration element. Each graphical element in the interface may have different arrangements and different visual representations, one or more elements of which may be omitted or replaced, and one or more other elements may also be present. Embodiments of the present disclosure are not limited in this respect.

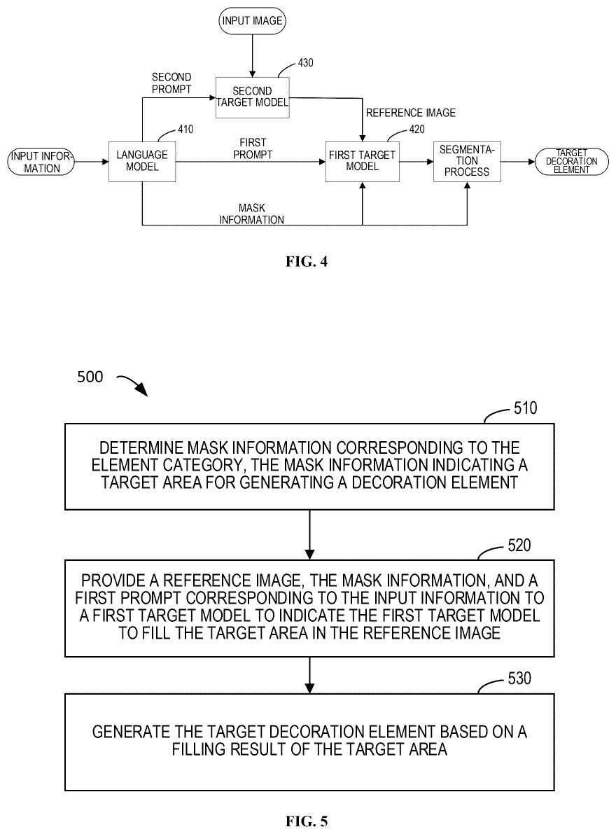

The specific generation process of the decoration element will be further described below with reference to FIG. 4 and FIG. 5. FIG. 4 illustrates a flowchart of an example process of generating a decoration element according to some embodiments of the present disclosure. FIG. 5 illustrates a flowchart of an example process 500 of generating a decoration element according to some embodiments of the present disclosure. It should be understood that the decoration element may be generated by the terminal device 110 and/or the server 130, and the process 500 will be described below with the server 130 as an example.

As shown in FIG. 5, at block 510, the server 130 determines mask information corresponding to the element category. The mask information indicates a target area for generating a decoration element.

As shown in FIG. 4, the server 130 may determine, based on the element category indicated by the input information, the mask information corresponding to the element category with the language model 410. In some embodiments, different categories of decoration elements may correspond to different placement areas. As an example, the hat and necktie may correspond to different wearing positions.

Additionally, the placement area of the decoration element may also depend on the reference object decorated by each category of the decoration element. For example, the placement area of the hat element may be determined based on the head position of the reference character of the target image.

In order to enable the generated decoration element to be placed in an appropriate placement area, the server 130 may establish a mapping relationship between each element category and an area in which the decoration element is generated. That is, the server 130 may preset mask information of each element category. After the server 130 determines the element category indicated by the input information, the server 130 may determine, based on the determined element category, mask information corresponding to the element category from a set of candidate mask information corresponding to a set of candidate element categories (for example, different types of decoration elements).

At block 520, the server 130 provides a reference image, the mask information, and a first prompt corresponding to the input information to a first target model 420 to indicate the first target model 420 to fill the target area in the reference image.

In some embodiments, the first target model 420 is a generative model with in-painting capability. The first target model 420 may predict and fill the content of the specified area based on the existing image information. As an example, before performing filling on the target area with the first target model 420, the server 130 may further provide a reference image, so that the filling result of the first target model 420 has higher adaptability and authenticity.

In some embodiments, the reference image may be determined based on a target image comprising the reference object. In some embodiments, the reference object may be associated with a target decoration element to be generated, and the reference image may comprise a visual representation corresponding to the reference object. As an example, the server 130 may obtain a preset reference image from a storage device thereof. Alternatively, the server 130 may also process the received input image with the second target model 430 to determine the reference image.

In some embodiments, the input image may be, for example, an image captured or uploaded by a user. Further, the server 130 may process the input image with the second target model 430 to generate a reference image matching the element style indicated in the input information. In this way, the embodiments of the present disclosure may enable the first target model 420 to fill the target area based on the reference image having the matching style, such that the generated target decoration element is more uniform with the style of the reference image.

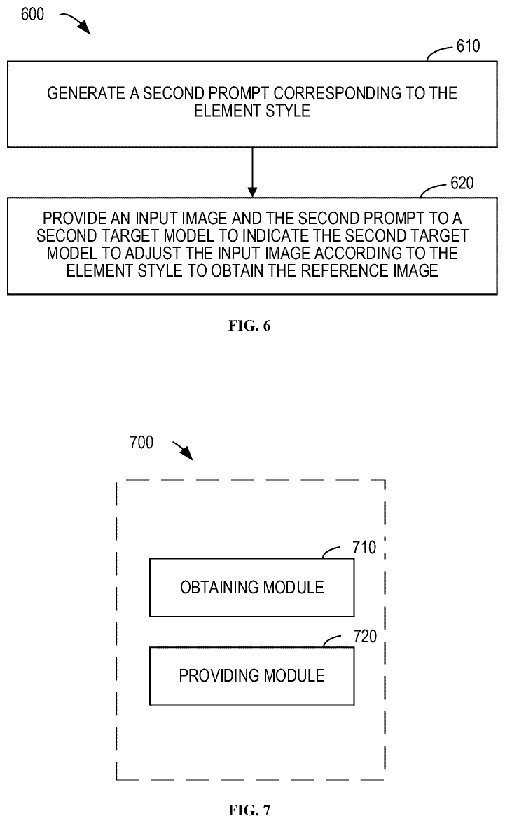

FIG. 6 further illustrates a specific process of generating a reference image. As shown if the figure, at block 610, the server 130 may generate a second prompt corresponding to the element style.

In some embodiments, the content described by the second prompt may be more detailed than the content described by the element style indicated in the input information. For example, the server 130 may expand the element style indicated in the input information with the language model 410, to obtain the second prompt.

At block 620, the server 130 may provide an input image and the second prompt to a second target model 430 to indicate the second target model 430 to adjust the input image according to the element style to obtain the reference image.

As an example, the second target model 430 may comprise an appropriate style control model such as ControlNet, Diffusion Model, or the like. The second target model 430 may adjust the input image based on the second prompt to output a reference image matching the target style indicated by the second prompt. In an example, the element style in the input information is style A, and the second target model 430 may convert the input image (for example, a portrait image) into a reference image matching the style A.

With continued reference to FIG. 4, the server 130 may provide the first prompt to the first target model 420 to indicate the first target model 420 to fill the target area indicated by the mask information based on the first prompt and the reference image. In some embodiments, the server 130 may process the input information with the language model 410 to generate a first prompt. In some examples, the first prompt may comprise, but is not limited to, two types of information of an element category and an element style. For example, the first prompt may be generated by filling the element category and the element style into a preset prompt template.

In some embodiments, the part of the first prompt associated with the element style may be content obtained after the element style is expanded, to facilitate that the first target model 420 may fill the target area more accurately.

With continued reference to FIG. 5, at block 530, the server 130 may generate the target decoration element based on the filling result of the target area.

Taking the hat element as an example, the first target model 420 may fill the target area (the preset area of the head of the portrait) indicated by the mask information based on the reference image (for example, the portrait image) and the first prompt (for example, the description content of the hat element) to obtain the filling result of the target area.

In some embodiments, the server 130 may obtain an intermediate image generated by filling the target area in the reference image with the first target model 420, and may segment the target decoration element from the intermediate image.

For example, the image generated by the first target model 420 may comprise, for example, an intermediate image filled with hat element. Further, the server 130 may segment the hat element from the intermediate image to complete the generation of the hat element. For example, the server 130 may determine an area in the intermediate image corresponding to the hat with an appropriate entity segmentation model.

In some embodiments, in order to improve the accuracy of the segmentation, the server 130 may further segment the target decoration element from the intermediate image based on the mask information. For example, the server 130 may only perform entity segmentation on the sub-image corresponding to the mask information in the intermediate image, thereby improving accuracy of image segmentation.

Based on the process described above, in the embodiments of the present disclosure, when generating the target decoration element with the first target model, by setting the target area, an area for generating the target decoration element can be effectively defined, so as to define the size and the position of the target decoration element. Therefore, the embodiments of the present disclosure can enhance the authenticity and adaptability of the target decoration element. In addition, when generating the target decoration element with the first target model, the embodiments of the present disclosure can further combine the reference image containing the element style, thereby improving the adaptability between the target decoration element and the decorated image.

### Example Apparatus And Device

Embodiments of the present disclosure also provide a corresponding apparatus for implementing the above method or process. FIG. 5 shows a schematic structural block diagram of an example apparatus 700 for providing a decoration element according to some embodiments of the present disclosure. The apparatus 700 may be implemented or included in the terminal device 110. The various modules/components in the apparatus 700 may be implemented by hardware, software, firmware, or any combination thereof.

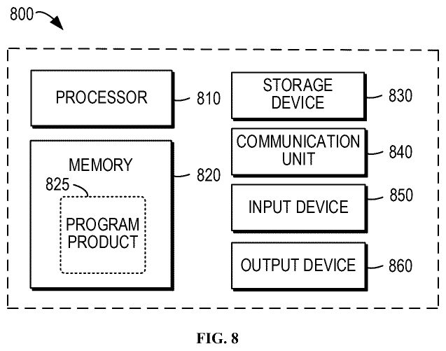

As shown in FIG. 7, the apparatus 700 comprises: an obtaining module 710, configured to obtain input information indicating an element category and an element style; and a providing module 720, configured to provide a target decoration element generated based on the input information, wherein the target decoration element is generated by: determining mask information corresponding to the element category, the mask information indicating a target area for generating a decoration element; providing a reference image, the mask information, and a first prompt corresponding to the input information to a first target model to indicate the first target model to fill the target area in the reference image; and generating the target decoration element based on a filling result of the target area.

In some embodiments, the reference image comprises a reference object associated with the target decoration element to be generated, and the mask information is associated with a position of the reference object in the reference image.

In some embodiments, the reference image has an image style matching the element style.

In some embodiments, the reference image is obtained by: generating a second prompt corresponding to the element style; and providing an input image and the second prompt to a second target model to indicate the second target model to adjust the input image according to the element style to obtain the reference image.

In some embodiments, the first prompt is generated by: processing the input information with a language model to generate the first prompt matching a preset prompt template.

In some embodiments, determining the mask information corresponding to the element category comprises: determining, from a set of candidate mask information corresponding to a set of candidate element categories, the mask information corresponding to the element category based on the element category.

In some embodiments, generating the target decoration element based on the filling result of the target area comprises: obtaining an intermediate image generated by filling the target area in the reference image with the first target model; and segmenting the target decoration element from the intermediate image.

In some embodiments, segmenting the target decoration element from the intermediate image comprises: segmenting the target decoration element from the intermediate image based on the mask information.

As shown in FIG. 8, the electronic device 800 is in the form of a general-purpose electronic device. Components of the electronic device 800 may comprise, but are not limited to, one or more processors or processing units 810, a memory 820, a storage device 830, one or more communication units 840, one or more input devices 850, and one or more output devices 860. The processing unit 810 may be an actual or virtual processor and capable of performing various processes according to programs stored in the memory 820. In multiprocessor systems, multiple processing units execute computer-executable instructions in parallel to improve parallel processing capabilities of electronic device 800.

Electronic device 800 typically includes a plurality of computer storage media. Such media may be any available media accessible to the electronic device 800, including, but not limited to, volatile and non-volatile media, removable and non-removable media. The memory 820 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 830 may be a removable or non-removable medium and may include a machine-readable medium, such as a flash drive, magnetic disk, or any other medium, which may be capable of storing information and/or data and may be accessed within electronic device 800.

The electronic device 800 may further include additional removable/non-removable, volatile/non-volatile storage media. Although not shown in FIG. 8, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 820 may include a computer program product 825 having one or more program modules configured to perform various methods or acts of various embodiments of the present disclosure.

The communication unit 840 is configured to communicate with another electronic device through a communication medium. Additionally, the functionality of components of the electronic device 800 may be implemented in a single computing cluster or multiple computing machines capable of communicating over a communication connection. Thus, the electronic device 800 may operate in a networked environment using logical connections with one or more other servers, network personal computers (PCs), or another network node.

The input device 850 may be one or more input devices such as a mouse, a keyboard, a trackball, or the like. The output device 860 may be one or more output devices, such as a display, a speaker, a printer, or the like. The electronic device 800 may also communicate with one or more external devices (not shown) through the communication unit 840 as needed, external devices such as storage devices, display devices, etc., communicate with one or more devices that enable a user to interact with the electronic device 800, or communicate with any device (e.g., a network card, a modem, etc.) that enables the electronic device 800 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram (s).

The computer-readable program instructions may be loaded onto a computer, other programmable data processing apparatus, or other devices, such that a series of operational steps are performed on a computer, other programmable data processing apparatus, or other device to produce a computer-implemented process such that the instructions executed on a computer, other programmable data processing apparatus, or other device implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or acts, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for generating a decoration element, comprising:
obtaining input information indicating an element category and an element style; and
providing a target decoration element generated based on the input information, wherein the target decoration element is generated by: determining mask information corresponding to the element category, the mask information indicating a target area for generating a decoration element; providing a reference image, the mask information, and a first prompt corresponding to the input information to a first target model to indicate the first target model to fill the target area in the reference image; and generating the target decoration element based on a filling result of the target area.

2. The method of claim 1, wherein the reference image comprises a reference object associated with the target decoration element to be generated, and the mask information is associated with a position of the reference object in the reference image.

3. The method of claim 2, wherein the reference image has an image style matching the element style.

4. The method of claim 3, wherein the reference image is obtained by: generating a second prompt corresponding to the element style; and providing an input image and the second prompt to a second target model to indicate the second target model to adjust the input image according to the element style to obtain the reference image.

5. The method of claim 1, wherein the first prompt is generated by: processing the input information with a language model to generate the first prompt matching a preset prompt template.

6. The method of claim 1, wherein determining the mask information corresponding to the element category comprises:
determining, from a set of candidate mask information corresponding to a set of candidate element categories, the mask information corresponding to the element category based on the element category.

7. The method of claim 1, wherein generating the target decoration element based on the filling result of the target area comprises:
obtaining an intermediate image generated by filling the target area in the reference image with the first target model; and
segmenting the target decoration element from the intermediate image.

8. The method of claim 7, wherein segmenting the target decoration element from the intermediate image comprises:
segmenting the target decoration element from the intermediate image based on the mask information.

9. An electronic device, comprising:
at least one processor; and
at least one memory, wherein the at least one memory is coupled to the at least one processor and stores instructions for execution by the at least one processor, and the instructions, when executed by the at least one processor, cause the electronic device to perform acts comprising:
obtaining input information indicating an element category and an element style; and
providing a target decoration element generated based on the input information, wherein the target decoration element is generated by: determining mask information corresponding to the element category, the mask information indicating a target area for generating a decoration element; providing a reference image, the mask information, and a first prompt corresponding to the input information to a first target model to indicate the first target model to fill the target area in the reference image; and generating the target decoration element based on a filling result of the target area.

10. The electronic device of claim 9, wherein the reference image comprises a reference object associated with the target decoration element to be generated, and the mask information is associated with a position of the reference object in the reference image.

11. The electronic device of claim 10, wherein the reference image has an image style matching the element style.

12. The electronic device of claim 11, wherein the reference image is obtained by: generating a second prompt corresponding to the element style; and providing an input image and the second prompt to a second target model to indicate the second target model to adjust the input image according to the element style to obtain the reference image.

13. The electronic device of claim 9, wherein the first prompt is generated by: processing the input information with a language model to generate the first prompt matching a preset prompt template.

14. The electronic device of claim 9, wherein determining the mask information corresponding to the element category comprises:
determining, from a set of candidate mask information corresponding to a set of candidate element categories, the mask information corresponding to the element category based on the element category.

15. The electronic device of claim 9, wherein generating the target decoration element based on the filling result of the target area comprises:
obtaining an intermediate image generated by filling the target area in the reference image with the first target model; and
segmenting the target decoration element from the intermediate image.

16. The electronic device of claim 15, wherein segmenting the target decoration element from the intermediate image comprises:
segmenting the target decoration element from the intermediate image based on the mask information.

17. A non-transitory computer-readable storage medium having a computer program stored thereon, wherein the computer program, when executed by a processor, implements acts comprising:
obtaining input information indicating an element category and an element style; and
providing a target decoration element generated based on the input information, wherein the target decoration element is generated by: determining mask information corresponding to the element category, the mask information indicating a target area for generating a decoration element;
providing a reference image, the mask information, and a first prompt corresponding to the input information to a first target model to indicate the first target model to fill the target area in the reference image; and generating the target decoration element based on a filling result of the target area.

18. The non-transitory computer-readable storage medium of claim 17, wherein the reference image comprises a reference object associated with the target decoration element to be generated, and the mask information is associated with a position of the reference object in the reference image.

19. The non-transitory computer-readable storage medium of claim 18, wherein the reference image has an image style matching the element style.

20. The non-transitory computer-readable storage medium of claim 19, wherein the reference image is obtained by: generating a second prompt corresponding to the element style; and providing an input image and the second prompt to a second target model to indicate the second target model to adjust the input image according to the element style to obtain the reference image.
